(19) United States
(12) Patent Application Publication
(10) Pub. No.: US 2023/0409252 A1
(43) Pub. Date: Dec. 21, 2023

(54) IMAGE FORMING SYSTEM AND IMAGE FORMING METHOD

(71) Applicant: Konica Minolta, Inc., Tokyo (JP)

(72) Inventor: TETSU KAWASAKI, Tokyo (JP)

(21) Appl. No.: 18/143,957

(22) Filed: May 5, 2023

(30) Foreign Application Priority Data
Jun. 17, 2022 (JP) 2022-098067

(51) Int. Cl. G06F 3/12; H04N 1/00

(52) U.S. Cl. CPC G06F 3/121; G06F 3/1219; G06F 3/1208; G06F 3/1256; H04N 1/00824

(57) ABSTRACT

An image forming system includes: a processing part that invalidates an eye mark formed on a medium by processing the eye mark; and a hardware processor that controls the processing part, wherein the hardware processor determines whether an image formed at a position corresponding to a position of the eye mark on the medium has an abnormality, and when the image has an abnormality, the hardware processor causes the processing part to process the eye mark corresponding to the image.

The entire disclosure of Japanese patent Application No. 2022-098067, filed on Jun. 17, 2022, is incorporated herein by reference in its entirety.

### BACKGROUND

### Technological Field

The present disclosure relates to an image forming system and an image forming method.

### Description of the Related Art

A technique of performing a specific process (image formation, overprinting, post-process, and the like) on a specific position in creation of a printed matter is known. JP 2020-67732 A discloses an image forming apparatus that prints a reusable object in a specific region of a recording medium and prints a variable unique object in another region.

In addition, in order to perform various processes on a continuous sheet such as roll paper, a technique using an image called an eye mark as a mark for alignment is known. JP 2020-37216 A discloses an image forming apparatus that shares an eye mark in a plurality of different processes. The image forming apparatus of JP 2020-37216 A forms an image so as to ignore some eye marks on the basis of the size of an image to be formed. As a result, the image forming apparatus of JP 2020-37216 A can form an image on a continuous sheet while ignoring an eye mark formed for a process other than image formation (for example, a subsequent process such as die cutting). As described above, by using an eye mark, an image can be formed and a post-process can be performed on a specific position of a continuous sheet.

However, the image forming apparatus cannot necessarily form an image normally for all the eye marks. For example, when image formation is started from a stopped state, there is a possibility that the image forming apparatus cannot perform normal image formation until a conveyance speed of a medium is stabilized. In some cases, although image formation is started, the image formation is interrupted in the image forming apparatus due to a defect of the apparatus, such as paper jam or toner runout. In some cases, image formation becomes abnormal due to contamination, poor toner density, and/or the like. For the above reasons, a situation in which the formed image has an abnormality is assumed.

In the image forming apparatus using an eye mark, a subsequent process such as overprinting and die cutting is performed on a region including an image having the abnormality as described above on the basis of a corresponding eye mark. Therefore, there has been a problem that toner is wastefully consumed, or a defective product needs to be removed from an output product, which causes trouble for a user.

### SUMMARY

Due to such circumstances, in an image forming apparatus using an eye mark, a means for suppressing execution of a subsequent process on a region including an image having an abnormality has been awaited.

To achieve the abovementioned object, according to an aspect of the present invention, an image forming system reflecting one aspect of the present invention comprises: a processing part that invalidates an eye mark formed on a medium by processing the eye mark; and a hardware processor that controls the processing part, wherein the hardware processor determines whether an image formed at a position corresponding to a position of the eye mark on the medium has an abnormality, and when the image has an abnormality, the hardware processor causes the processing part to process the eye mark corresponding to the image.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a diagram for describing a schematic configuration of an image forming system as an embodiment of an image forming apparatus;

FIG. 2 is a block diagram illustrating an example of a functional configuration of the image forming system;

FIG. 3 is a flowchart of an example of processes executed in an image forming system according to a first embodiment;

FIG. 4 is a flowchart of an example of processes executed in an image forming system according to a second embodiment; and

FIG. 5 is a flowchart of an example of a process executed in an image forming system according to a modification.

### DETAILED DESCRIPTION OF EMBODIMENTS

Hereinafter, one or more embodiments of an image forming apparatus of the present invention will be described with reference to the drawings. However, the scope of the invention is not limited to the disclosed embodiments. In the following description, the same parts and components are denoted by the same reference signs. The names and functions of the same parts and components are the same. Therefore, the description thereof will not be repeated.

### First Embodiment

<1. Configuration of Image Forming Apparatus>

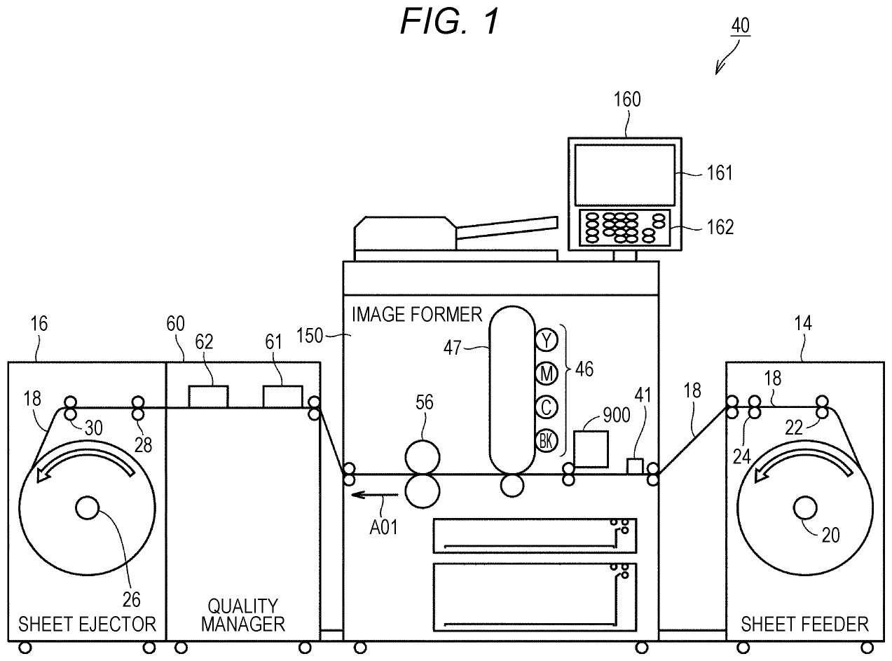

FIG. 1 is a diagram for describing a schematic configuration of an image forming system 40 as an embodiment of an image forming apparatus.

As illustrated in FIG. 1, the image forming system 40 includes a sheet feeder 14, an image former 150, an operation panel 160, a quality manager 60, and a sheet ejector 16. An arrow A01 in FIG. 1 indicates a conveyance direction of a continuous sheet 18.

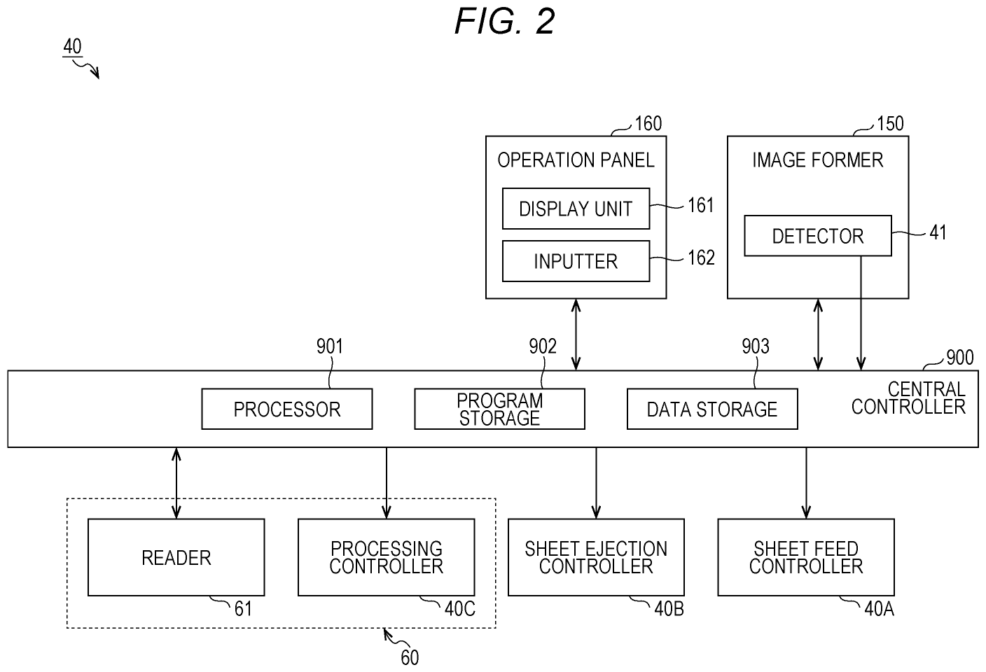

The sheet feeder 14 is a mechanism for holding the continuous sheet 18. In the image forming system 40 according to the first embodiment, the continuous sheet 18 is roll paper. The sheet feeder 14 includes a receiving shaft 20 of the continuous sheet 18 and rollers 22 and 24 for tension and guide. The operation of the sheet feeder 14 including rotation of the receiving shaft 20 is controlled by a computer (not shown) (a sheet feed controller 40A in FIG. 2 to be described below) in the sheet feeder 14.

The operation panel 160 includes a display unit 161 including a liquid crystal display or the like, and an inputter 162 that receives input of information. The inputter 162 includes a hardware button and/or a software button displayed on the display unit 161. In the first embodiment, the operation panel 160 is fixed to the image former 150, but may be detachable from the image former 150 or may be fixed to a part of the image forming system 40, other than the image former 150. The operation panel 160 may be a terminal such as a smartphone communicable with the image forming system 40.

The image former 150 is provided with a central controller 900 that controls operation of the image forming system 40. The central controller 900 includes an arithmetic device (a processor 901 in FIG. 2 to be described below) such as a central processing unit (CPU). The central controller 900 is an example of a “controller”.

The image former 150 is provided with a detector 41 that detects an eye mark formed on the continuous sheet 18. Specific examples of the detector 41 include a charge coupled device (CCD). The image former 150 forms an image at a position corresponding to the position of the eye mark detected by the detector 41.

The image former 150 forms an image by an electrophotographic process and transfers the image to a medium such as a continuous sheet. Specifically, the image former 150 includes an image bearer 46 that bear a toner image for each of yellow (Y), magenta (M), cyan (C), and black (BK), and an intermediate transfer belt 47 to which the toner image borne by the image bearer 46 is primarily transferred. The image transferred to the intermediate transfer belt 47 is secondarily transferred to the continuous sheet 18.

The image former 150 further includes a fixer 56 that fixes the transferred image to the continuous sheet 18. Note that various adjustment operations in the image forming system 40 can be started without waiting for the continuous sheet 18 to pass through the fixer 56.

In one embodiment, in the image former 150, conveyance of the continuous sheet 18 from the sheet feeder 14 is started, and after the conveyance speed is stabilized, image formation is started.

The quality manager 60 is a part for managing the quality of the continuous sheet 18 ejected from the image former 150. The quality manager 60 further includes a reader 61 that reads an image formed on the continuous sheet 18, and a processing part 62 that invalidates the eye mark by processing the eye mark. Upon determining that the image on the continuous sheet 18 has an abnormality, the processing part 62 invalidates the eye mark corresponding to the image.

Specific examples of the reader 61 include a CCD. The image read by the reader 61 is displayed on the display unit 161, for example. The display allows the user to observe the image. However, the means by which the user observes the image is not limited to the above. For example, instead of the reader 61, a part for allowing the user to directly visually recognize the continuous sheet 18 ejected from the image former 150 may be provided. The reader 61 may read and detect the eye mark in addition to the image.

An example of the processing part 62 is a mechanism that forms an image at the position of the eye mark. The mechanism that forms an image at the position of the eye mark is, for example, a mechanism that fills a part of the eye mark with an inker. Another example of the processing part 62 is a mechanism that adds a shield to the position of the eye mark. The mechanism that adds the shield to the position of the eye mark is, for example, a mechanism that attaches a sheet to the position of the eye mark. Another example of the processing part 62 is a mechanism that cuts out an eye mark. The mechanism that cuts out the eye mark may be, for example, a mechanism that die-cutting a region including the eye mark, or a mechanism that forms a punch hole at the position of the eye mark.

The sheet ejector 16 includes a shaft 26 that winding the continuous sheet 18 sent from the sheet ejection adjuster 90 via the quality manager 60, and rollers 28 and 30 that send the continuous sheet 18 to the shaft 26. The rotation operations of the rollers 28 and 30 and the shaft 26 in the sheet ejector 16 are controlled by a computer (not shown) (a sheet ejection controller 40B in FIG. 2 to be described below) in the sheet ejector 16.

As described above with reference to FIG. 1, in the image forming system 40, the continuous sheet 18 fed from the sheet feeder 14 is sent to the image former 150. The image former 150 forms an image on the continuous sheet 18 and outputs the continuous sheet 18 to the quality manager 60. When the formed image has an abnormality, the quality manager 60 invalidates the eye mark corresponding to the image by processing the eye mark. The continuous sheet 18 output from the quality manager 60 is sent to the sheet ejector 16 and wound around the shaft 26.

<2. Functional Block>

FIG. 2 is a block diagram illustrating an example of a functional configuration of the image forming system 40.

As illustrated in FIG. 2, the image forming system 40 includes the central controller 900. The central controller 900 includes the processor 901, a program storage 902 that stores a program executed by the processor 901, and a data storage 903 that stores various data used for executing the program. In some cases, the program executed by the processor 901 is stored in a storage device other than the central controller 900. In some cases, the program executed by the processor 901 is non-temporarily stored in a storage medium detachable from the image former 150.

The central controller 900 controls the image former 150, the operation panel 160, the sheet feed controller 40A, the sheet ejection controller 40B, a processing controller 40C, and the reader 61 by the processor 901 executing a given program. Note that the sheet feed controller 40A controls the sheet feeder 14. The sheet ejection controller 40B controls the sheet ejector 16. The processing controller 40C controls the processing part 62.

The central controller 900 forms an image at a position corresponding to the position of the eye mark detected by the detector 41. Specifically, for example, after a predetermined time elapses after the eye mark is detected, image formation is started. The predetermined time is determined on the basis of the conveyance speed.

An image read by the reader 61 is input to the central controller 900, and the central controller 900 determines whether the image formed on the continuous sheet 18 has an abnormality on the basis of the image. Then, upon determining that the image formed on the continuous sheet 18 has an abnormality, the central controller 900 controls the processing part 62 to process the eye mark corresponding to the image. Details of the determination as to whether the image has an abnormality will be described later.

As described above, the central controller 900 integrally controls the image forming system 40.

<3. Flow of Processes>

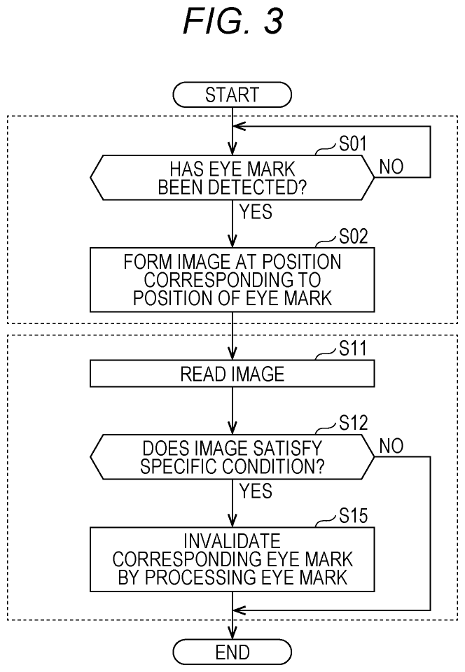

Next, the contents of a process in which the central controller 900 determines whether an image has an abnormality will be described. FIG. 3 is a flowchart of an example of the process. Steps (hereinafter, a step is also referred to as “S”) 01 to S02 are performed by the central controller 900 controlling the image former 150. S11, S12, and S15 are performed by the central controller 900 controlling the quality manager 60. Each step illustrated in FIG. 3 is performed for each eye mark formed on the continuous sheet 18.

Referring to FIG. 3, in S01, the central controller 900 determines whether an eye mark has been detected on the continuous sheet 18. The central controller 900 remains the control in S01 until it is determined that the eye mark has been detected, and advances the control to S02 when it is determined that the eye mark has been detected.

In S02, the central controller 900 forms an image at a position corresponding to the position of the eye mark detected in S01. For example, the central controller 900 causes the image former 150 to start image formation after a predetermined time has elapsed from the timing at which the eye mark is detected, and thus forms an image at a position corresponding to the position of the eye mark in the conveyance direction of the continuous sheet 18. The central controller 900 causes the image former 150 to start image formation from a predetermined position with respect to the position where the eye mark is detected in a direction orthogonal to the conveyance direction of the continuous sheet 18, and thus forms an image at a position corresponding to the position of the eye mark in the direction orthogonal to the conveyance direction of the continuous sheet 18.

In S11, the central controller 900 reads an image formed on the continuous sheet 18.

In S12, the central controller 900 determines whether the image read in S11 has an abnormality. For example, the central controller 900 determines whether the read image satisfies a specific condition. The specific condition is a condition for determining that the image has an abnormality, and is a condition related to the quality of the image. The central controller 900 can determine whether the image has reached a quality included in a completed product on the basis of the specific condition.

In one example, in S12, the central controller 900 compares a sample image stored in the data storage 903 with the read image to detect a difference. The sample image corresponds to an image formed on the continuous sheet 18 when the image former 150 operates properly.

The specific condition includes, for example, a condition regarding at least one of missing of at least a part of the read image, a positional deviation of the read image, a color difference in at least a part of the read image, a density difference in at least a part of the read image, a smear on the read image, an image streak in the read image, or density unevenness in the read image, the at least one being detected when the sample image is compared with the read image.

The condition regarding the missing of at least a part of the read image defines, for example, that at least a part of the read image is missing as compared with the sample image.

The condition regarding the positional deviation of the read image defines, for example, that the position of the read image is deviated by a predetermined distance or more from the position of the sample image.

The condition regarding the color difference in at least a part of the read image defines that, for example, in at least a part of the read image, a numerical value related to color differs by a predetermined value or more from a numerical value related to color of a corresponding part of the sample image. The numerical value related to color is, for example, at least one numerical value of hue, saturation, or brightness.

The condition regarding each of the density difference in at least a part of the read image, the smear on the read image, the image streak in the read image, and the density unevenness in the read image defines that, in at least a part of the read image, the numerical value related to color is different from the numerical value related to color of the corresponding part of the sample image by a predetermined value or more, similarly to the above condition regarding the color difference.

When an image satisfies the specific condition (YES in S12), the central controller 900 controls the processing part 62 in S15 to invalidate the eye mark corresponding to the image by processing the eye mark, and ends the process of FIG. 3. At least a part of the eye mark is changed by invalidation by the processing part 62. The invalidation is performed, for example, by forming an image on the eye mark, adding a shield to the eye mark, or cutting out the eye mark. The central controller 900 may invalidate the eye mark by rewinding the continuous sheet 18 and causing the image former 150 to form an image on the eye mark corresponding to the image having an abnormality. The image former 150 in this case constitutes an example of a “processing part”.

When the image read in S11 does not satisfy the specific condition (NO in S12), the central controller 900 ends the process of FIG. 3 without executing the process of S15.

The process of S11 may include a process of detecting the eye mark by reading the eye mark in addition to the image by the reader 61. By detection of the eye mark in S11, the central controller 900 can confirm the position of the image and the position of the eye mark on the reader 61 in S12. As a result, the central controller 900 can easily determine whether an image is formed at a correct position on the basis of the position of the eye mark. Note that, in S12, the central controller 900 also determines whether the image corresponds to a specific condition other than the condition of the position of the image. Furthermore, in S12, the central controller 900 can confirm the position of the eye mark immediately before processing the eye mark in the processing part 62. As a result, even when the time at which the eye mark reaches the processing part 62 is not consistent with the time at which the eye mark is detected by the detector 41 and a calculated value based on the set conveyance speed due to some cause, the timing of processing the eye mark can be adjusted. Note that the cause described above may be, for example, sagging of the continuous sheet 18, a defect of the image former, a defect of a conveyance operation, or the like.

In the process of FIG. 3, upon detection that the image has an abnormality, the central controller 900 controls the central controller to control the processing part 62 to process and invalidate the corresponding eye mark. It is possible to easily determine whether the image has an abnormality by determining whether the specific condition regarding the quality of the image is satisfied particularly by using the reader 61. As a result, it is possible to easily suppress the subsequent process from being performed on the region including the image having an abnormality. It is therefore possible to reduce unnecessary labor, time, and cost spent on the subsequent process on the region including the image having the abnormality. Note that a region including an image having an abnormality herein indicates a region including an image having an abnormality and a margin corresponding to the image.

The subsequent process herein indicates a process performed on the continuous sheet 18 on which an image has been formed. A completed product is created by performing the subsequent process on the continuous sheet 18 on which an image has been formed. The subsequent process includes, for example, at least one of overprinting, die cutting, perforating, folding, or cutting. Therefore, it can be said that the process of FIG. 3 can suppress unnecessary toner consumption and reduce the effort for the user to confirm and remove a defective product.

The subsequent process may be performed by a post-process device separate from the image forming system 40. The image forming system 40 may further include a device that performs the subsequent process, and the subsequent process may be performed in the image forming system 40.

In the image forming system 40, although an eye mark is detected in S01, image formation is not performed in S02 in some cases. An example of a case where image formation is not performed is a case where the image former 150 is in a state in which it is assumed that toner is not normally discharged. Another example is a case where the image forming system 40 is in a state where image formation is not performed because the conveyance speed is not stabilized immediately after the start of conveyance of the continuous sheet 18 or immediately before the end of conveyance. In this case, in S11, the central controller 900 performs a reading process on the region corresponding to the eye mark. In S12, since at least a part of the image is missing, the central controller 900 determines that the specific condition is satisfied.

### Second Embodiment

The image forming system 40 according to a second embodiment is different from the image forming system 40 according to the first embodiment in the process of determining whether a formed image has an abnormality.

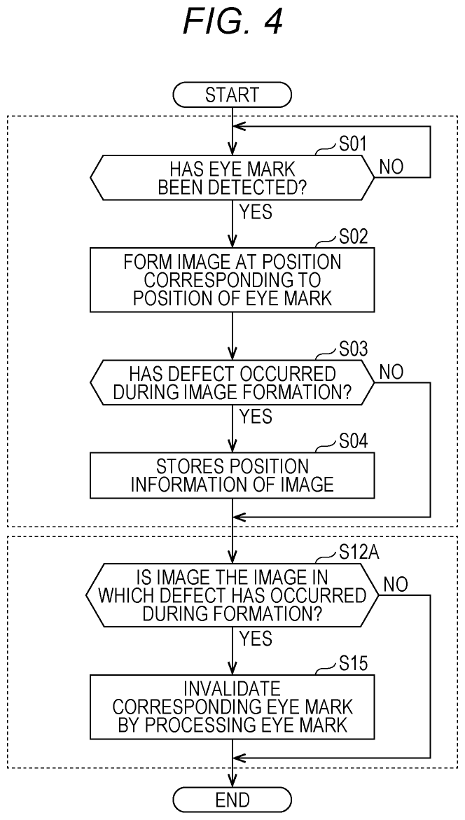

In the image forming system 40 according to the second embodiment, the process illustrated in FIG. 3 of the first embodiment is changed to a process illustrated in FIG. 4. FIG. 4 is a flowchart of an example of processes executed in the image forming system 40 according to the second embodiment. S01 to S04 in FIG. 4 are performed by the central controller 900 controlling the image former 150. S12A and S15 are performed by the central controller 900 controlling the quality manager 60. S01, S02, and S15 in FIG. 4 correspond to S01, S02, and S15 in FIG. 3, and thus, the description thereof will not be repeated.

In S03 in FIG. 4, the central controller 900 determines whether a defect has occurred in the image former 150 at the time of forming the image in S02. The defect indicates a condition of the image forming system 40 that is considered to cause an abnormality in image formation. Therefore, when a defect occurs during image formation, the image formed when the defect occurs is highly likely to have an abnormality. As described above, if a defect occurs during image formation, an image formed at the time of occurrence of the defect is herein also included in one aspect of the “image having an abnormality”.

The defect includes, for example, a defect related to the toner discharge or a defect related to the conveyance speed. An example of the defect related to the toner discharge is a defect that a toner discharge amount does not reach a specified amount. The defect that the toner discharge amount does not reach the specified amount may be detected by monitoring the discharge amount itself, or may be detected by the remaining amount of a toner cartridge not reaching a specified value in the image former 150. Note that the toner is an example of an image forming material. Another example of the image forming material is ink. In a case where the ink is adopted as the image forming material, it is determined whether a “defect related to the ink discharge” has occurred instead of the “defect related to the toner discharge”.

An example of the defect related to the conveyance speed is a defect in which the conveyance speed does not exceed a specified speed. The specified speed is, for example, an upper limit value of a speed in a period in which image formation is not performed immediately after the start of conveyance of the continuous sheet 18 or immediately before the end of conveyance of the continuous sheet 18. The conveyance speed may be detected by, for example, the rotation speed of the receiving shaft 20, or may be calculated on the basis of a passing speed of the eye mark in the detector 41.

Upon determining that a defect has occurred while an image is being formed (YES in S03), in S04, the central controller 900 stores information regarding the position of the image or information regarding the position of the eye mark corresponding to the image, and advances the process to S12A. Specifically, the information regarding the position of the image or the eye mark includes, for example, a passage time at which the image passes through the image former 150.

Subsequently to S04 or when it is not determined that a defect has occurred during image formation (NO in S03), the central controller 900 advances the process to S12A.

In S12A, the central controller 900 determines whether the image that has reached the quality manager 60 is an image in which a defect has occurred during formation. The determination in S12A is based on the memory of information regarding the position of the image determined to have a defect during formation or information regarding the position of the eye mark corresponding to the image. Specifically, for example, the central controller 900 determines whether the image that has reached the quality manager 60 is an image in which a defect has occurred during formation on the basis of the passage time of the image former 150 and the conveyance speed.

When the image is an image in which a defect has occurred during formation (YES in S12A), in S15, the central controller 900 controls the processing part 62 to invalidate the eye mark corresponding to the image by processing the eye mark, and ends the process of FIG. 4.

When the image is not an image in which a defect has occurred during formation (NO in S12A), the central controller 900 ends the process of FIG. 4.

In the process of FIG. 4, when a defect occurs during image formation, the central controller 900 controls the central controller to control the processing part 62 to process and invalidate the corresponding eye mark. As a result, the subsequent process is not performed on the region corresponding to the invalidated eye mark. Therefore, it is possible to reduce unnecessary labor, time, and cost regarding the subsequent process on the region including the image having an abnormality.

The process of FIG. 4 may further include the process of S12 of FIG. 3. That is, the central controller 900 may perform the process of S12 upon determining in S12A that the image that has reached the quality manager 60 is not an image in which a defect has occurred during formation. Then, upon determining that the image that has reached the quality manager 60 corresponds to the above “specific condition” in the process of S12, the central controller 900 may execute the process of S15 and end the process of FIG. 4. Upon determining that the image that has reached the quality manager 60 does not correspond to the above “specific condition” in the process of S12, the central controller 900 may end the process of FIG. 4 without executing the process of S15.

### Modification

The image forming system 40 according to a modification of the first and second embodiments includes a process in which upon determining by the central controller 900 that the image has an abnormality, the user observes the image and selects whether to process the eye mark.

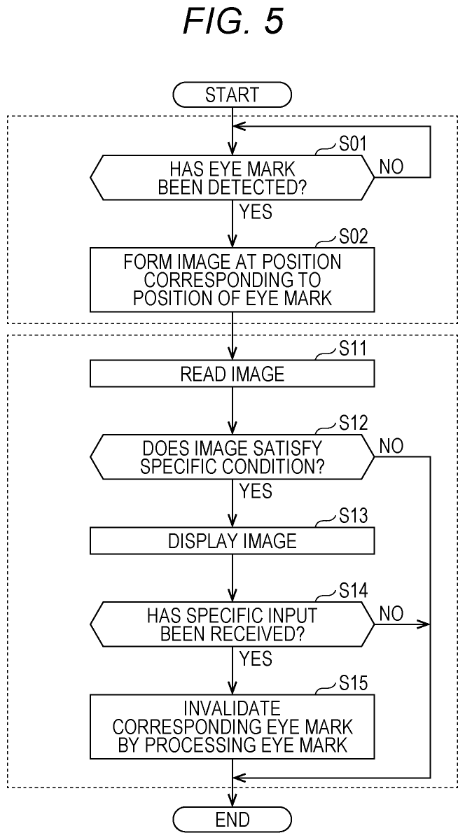

FIG. 5 is a flowchart of an example of a process executed in the image forming system 40 according to the modification. In the image forming system 40 according to the modification, as compared with the first embodiment, S13 and S14 are added between S12 and S15 (FIG. 5). Similarly, as compared with the second embodiment, S13 and S14 are added between S12A and S15 (not shown).

S01 to S02 in FIG. 5 are performed by the central controller 900 controlling the image former 150. S11 and S15 are performed by the central controller 900 controlling the quality manager 60. S01, S02, S11, S12, and S15 in FIG. 5 correspond to S01, S02, S11, S12, and S15 in FIG. 3.

Upon determining that the image satisfies the specific condition in S12 of FIG. 5 (YES in S12), the central controller 900 displays the image on the display unit 161 in S13.

When the user observes the image and confirms that the image has an abnormality, the user performs specific input by using the inputter 162. The specific input is performed, for example, by pressing a hardware button and/or a software button. The specific input corresponds to an example of “input”.

In a case where the inputter received the specific input (YES in S14), the central controller 900 controls the processing part 62 to invalidate the eye mark corresponding to the image by processing the eye mark, and ends the process.

In a case where the inputter has not received the specific input (NO in S14), the central controller 900 ends the process without processing the eye mark corresponding to the image.

In the process of FIG. 5, upon determining that the image has an abnormality, the central controller 900 can reflect the determination based on the visual recognition by the user as to whether to invalidate the eye mark corresponding to the image (in order to avoid a subsequent process on the image). That is, the image forming system 40 can leave to the user a final determination as to whether the image determined to have an abnormality by the central controller 900 may be included in the completed product.

Specifically, when the central controller 900 determines that a certain image has an abnormality, but human eyes determine that the image can endure practical use, the subsequent process is performed on the image. It is therefore possible to determine that, for example, an image having a slight abnormality that is not visually noticeable is included in the completed product. That is, from the viewpoint that the number of defective products can be reduced, waste of the continuous sheet 18 and the toner can be reduced.

As described above, in the image forming systems 40 according to the first and second embodiments and the modification, it is possible to easily perform quality control by using a simple configuration of invalidating the eye mark corresponding to the image having an abnormality.

Although embodiments of the present invention have been described and illustrated in detail, the disclosed embodiments are made for purposes of illustration and example only and not limitation. The scope of the present invention should be interpreted by terms of the appended claims, and it is intended that meanings equivalent to the claims and all changes within the scope are included.

What is claimed is:

1. An image forming system comprising:
a processing part that invalidates an eye mark formed on a medium by processing the eye mark; and
a hardware processor that controls the processing part, wherein
the hardware processor determines whether an image formed at a position corresponding to a position of the eye mark on the medium has an abnormality, and
when the image has an abnormality, the hardware processor causes the processing part to process the eye mark corresponding to the image.

2. The image forming system according to claim 1, further comprising an image former that forms the image.

3. The image forming system according to claim 1, wherein the processing part processes the eye mark by at least one of forming an image at the position of the eye mark, adding a shield to at least a part of the eye mark, or cutting out the position of the eye mark.

4. The image forming system according to claim 2, wherein the hardware processor determines that the image has an abnormality when a defect occurs in the image former during formation of the image.

5. The image forming system according to claim 4, wherein the defect includes a defect related to discharge of an image forming material in the image former or a defect related to a conveyance speed.

6. The image forming system according to claim 1, further comprising a reader that reads the image, wherein
the hardware processor determines that the image has an abnormality when the image read by the reader satisfies a specific condition.

7. The image forming system according to claim 6, wherein the specific condition includes a condition regarding at least one of missing of at least a part of the image having been read, a positional deviation of the image having been read, a color difference in at least a part of the image having been read, a density difference in at least a part of the image having been read, a smear on the image having been read, an image streak in the image having been read, or density unevenness in the image having been read, the at least one being detected when a sample image is compared with the image having been read.

8. The image forming system according to claim 1, further comprising an inputter that receives an input from outside, wherein
the hardware processor displays the image on a display upon determining that the image has an abnormality,
the hardware processor determines whether the inputter has received the input from the outside in response to the displaying the image on the display,
the hardware processor causes the processing part to process the eye mark in a case where the inputter has received the input from the outside, and
the hardware processor does not cause the processing part to process the eye mark in a case where the inputter has not received the input from the outside.

9. An image forming method comprising:
detecting an eye mark formed on a medium;
determining whether an image formed at a position corresponding to a position of the eye mark on the medium has an abnormality; and
invalidating, when the image has an abnormality, the eye mark corresponding to the image by processing the eye mark.

10. The image forming method according to claim 9, further comprising forming the image at the position corresponding to the position of the eye mark on the medium.

11. The image forming method according to claim 9, wherein the invalidating includes invalidating the eye mark by processing the eye mark by at least one of forming an image at the position of the eye mark, adding a shield to at least a part of the eye mark, or cutting out the position of the eye mark.

12. The image forming method according to claim 10, wherein the determining includes determining that the image has an abnormality when a defect occurs in the forming of the image.

13. The image forming method according to claim 12, wherein the defect includes a defect related to discharge of an image forming material or a defect related to a conveyance speed.

14. The image forming method according to claim 9, further comprising reading the image, wherein
the determining includes determining that the image has an abnormality when the image read in the reading satisfies a specific condition.

15. The image forming method according to claim 14, wherein the specific condition includes a condition regarding at least one of missing of at least a part of the image having been read, a positional deviation of the image having been read, a color difference in at least a part of the image having been read, a density difference in at least a part of the image having been read, a smear on the image having been read, an image streak in the image having been read, or density unevenness in the image having been read, the at least one being detected when a sample image is compared with the image having been read.

16. The image forming method according to claim 9, further comprising:
upon determining that the image has an abnormality in the determining,
displaying the image on a display; and
determining whether an input from outside has been received in response to the displaying the image on the display, wherein
the invalidating is performed only in a case where the input from the outside has been received, and is not performed in a case where the input from the outside has not been received.
